(19) United States
(12) Patent Application Publication
(10) Pub. No.: US 2010/0050869 A1
(43) Pub. Date: Mar. 4, 2010

(54) Plate System For Contaminant Removal

(76) Inventors: Kishor Purushottam Gadkaree, Big Flats, NY (US); Joseph Frank Mach, Lindley, NY (US); Youchun Shi, Horseheads, NY (US)

Correspondence Address: CORNING INCORPORATED, SP-TI-3-1, CORNING, NY, 14831, US

(21) Appl. No.: 12/542,165

(22) Filed: Aug. 17, 2009

Related U.S. Application Data
(60) Provisional application No. 61/190,402, filed on Aug. 28, 2008.

(51) Int. Cl. B01D 53/04

(52) U.S. Cl. 95/134; 95/133; 96/131; 96/121; 95/90; 96/154

(57) ABSTRACT

Plate systems and methods of using them. The plate systems may be used, for example, for the removal of metallic or semi-metallic contaminants from a fluid stream.

### CROSS-REFERENCE TO RELATED APPLICATIONS

This application claims the benefit of priority under 35 U.S.C. §119(e) of U.S. Provisional Application No. 61/190402 filed on Aug. 28, 2008, the content of which is relied upon and incorporated herein by reference in its entirety.

### FIELD OF THE DISCLOSURE

This disclosure relates to plate systems and methods of using them. The plate systems may be used, for example, for the removal of metallic or semi-metallic contaminants from a fluid stream.

### BACKGROUND

Hazardous contaminant emissions have become environmental issues of increasing concern because of the potential dangers posed to human health. For instance, coal-fired power plants and medical waste incineration are major sources of human activity related to contaminant emissions into the atmosphere.

One DOE-Energy Information Administration annual energy outlook projected that coal consumption for electricity generation will increase from 976 million tons in 2002 to 1,477 million tons in 2025 as the utilization of coal-fired generation capacity increases. However, emission control regulations for some contaminants have not been rigorously enforced for coal-fired power plants. A major reason is a lack of effective control technologies available at a reasonable cost.

A technology currently in use for controlling elemental mercury as well as oxidized mercury is activated carbon injection (ACI). The ACI process involves injecting activated carbon powder into a flue gas stream and using a fabric filter or electrostatic precipitator to collect the activated carbon powder that has sorbed mercury. ACI technologies generally require a high C:Hg ratio to achieve the desired mercury removal level (>90%), which results in a high portion cost for sorbent material. The high C:Hg ratio indicates that ACI does not utilize the mercury sorption capacity of carbon powder efficiently.

Activated carbon honeycombs disclosed in US 2007/0261557, for example, may be utilized to achieve high removal levels of contaminants such as toxic metals. The inventors have now discovered new systems that can be used for the removal of contaminants from fluids, which are described herein.

Plate systems of the invention are expected in some embodiments to be associated with low pressure drop as a fluid flows through the systems. The plates may also involve less costly processing steps compared to sorbents of more complex geometry.

### SUMMARY

One embodiment of the invention includes a method for removing a metallic or semi-metallic contaminant from a fluid stream, which comprises:
providing a system comprising a stack of sorbent plates, wherein adjacent sorbent plates in the stack are separated by a flow space; and
passing the fluid stream comprising a metallic or semi-metallic contaminant through one or more flow spaces in the stack.

Another embodiment of the invention includes a sorbent plate system comprising:
a stack of sorbent plates, wherein adjacent sorbent plates in the stack are separated by a flow space; and
wherein one or more of the sorbent plates comprise activated carbon and further comprises (i) sulfur, (ii) a metal catalyst, or (iii) sulfur and a metal catalyst.

### BRIEF DESCRIPTION OF THE DRAWINGS

The invention can be understood from the following detailed description either alone or together with the accompanying drawings. The drawings are included to provide a further understanding of the invention, and are incorporated in and constitute a part of this specification. The drawings illustrate one or more embodiments of the invention and together with the description serve to explain the principles and operation of the invention.

FIG. 1 is an example plate system with flat parallel plates suitable for the practice of the invention.

FIG. 2 is an example plate system with curved plates suitable for the practice of the invention.

FIG. 3 is an example plate system with bends suitable for the practice of the invention.

FIG. 4 is an example plate system with corrugated plates suitable for the practice of the invention.

FIG. 5 is an example plate system with spacers between the plates in the stack suitable for the practice of the invention.

FIG. 6 is an example plate system with protrusions forming a gap between plates in the stack suitable for the practice of the invention.

### DESCRIPTION OF EMBODIMENTS

One embodiment of the invention includes a method for removing a metallic or semi-metallic contaminant from a fluid stream, which comprises:
providing a system comprising a stack of sorbent plates, wherein adjacent sorbent plates in the stack are separated by a flow space; and
passing the fluid stream comprising a metallic or semi-metallic contaminant through one or more flow spaces in the stack;
wherein one or more of the sorbent plates comprise activated carbon and further comprise (i) sulfur, (ii) a metal catalyst, or (iii) sulfur and a metal catalyst.

The metallic or semi-metallic contaminant may be removed from the fluid stream through contact of the fluid stream with one or more sorbent plates as the fluid passes through a flow space. In one embodiment, this method comprises removing a metallic contaminant from the fluid stream, while in another embodiment the method comprises removing a semi-metallic contaminant from the fluid stream.

The terms “sorb,” “sorption,” and “sorbed” used herein refer to the adsorption, absorption, or other entrapment of the contaminant on the sorbent plates, either physically, chemically, or both physically and chemically, thereby removing the contaminant from the fluid stream.

The terms “remove,” “removal,” and “removing” used to describe the removal of a contaminant from the fluid stream refer to reducing the content of the contaminant in the fluid stream to any extent. Thus, removal of a contaminant from a fluid stream includes removing, for example, at least 50%, at least 60%, at least 70%, at least 80%, at least 90%, or at least 95% of the contaminant from the fluid stream, or removing 100% of the contaminant from the fluid stream.

Exemplary contaminants include, for instance, contaminants at 3 wt % or less within the fluid stream, for example at 2 wt % or less, or 1 wt % or less. Contaminants may also include, for instance, contaminants at 10,000 pg/m³ or less within the fluid stream. Reference to metallic and semi-metallic contaminants, and reference to a particular metallic contaminant, semi-metallic contaminant, or other contaminant by name, includes the elemental forms as well as oxidation states of the contaminant. Sorption and removal of a contaminant from a fluid stream thus includes sorption and removal of the elemental form of the contaminant and/or sorption and removal of any organic or inorganic compound or composition comprising the contaminant.

Example metallic contaminants include cadmium, mercury, chromium, lead, barium, beryllium, and chemical compounds or compositions comprising those elements. In one embodiment, the contaminant is mercury in an elemental (Hg°) or oxidized state (Hg⁺ or Hg²⁺). Example forms of oxidized mercury include HgO and halogenated mercury, for example Hg₂Cl₂ and HgCl₂. Other exemplary metallic contaminants include nickel, cobalt, vanadium, zinc, copper, manganese, antimony, silver, and thallium, as well as organic or inorganic compounds or compositions comprising them. Additional metallic or semi-metallic contaminants include arsenic and selenium as elements and in any oxidation states, and organic or inorganic compounds or compositions comprising arsenic or selenium.

The contaminant may be in any phase suitable for practice of the invention. Thus, the contaminant may be present, for example, as a liquid in a gas fluid steam, or as a liquid in a liquid fluid stream. The contaminant could alternatively be present as a gas phase contaminant in a gas or liquid fluid stream. In one embodiment, the contaminant is a vapor in a coal combustion flue gas, oil combustion flue gas, or syngas stream.

The fluid stream may be in the form of a gas or a liquid. The gas or liquid may also contain another phase, such as a solid particulate in either a gas or liquid stream, or droplets of liquid in a gas stream. Example gas streams include coal combustion flue gases (such as from bituminous and sub-bituminous coal types or lignite coal), oil combustion flue gases, and syngas streams produced in a coal gasification process.

The sorbent plates used in the context of the invention may be made of any material suitable for the sorption of the contaminant from a fluid stream. The sorbent plates, may, for example, have a homogenous structure or may comprise a substrate coated with a sorbent material. For instance, the sorbent plates may comprise a glass, glass-ceramic, ceramic, metal, metal-ceramic, polymer, or inorganic-organic composite plate coated with a sorbent material. Additional exemplary materials for the sorbent plates include compositions disclosed in PCT/US08/06082, filed on May 13, 2008, the contents of which are incorporated herein.

In some embodiments, one or more of the plates may comprise activated carbon, either as a plate itself or as a coating on a plate made of a different material. Such activated carbon plates may also comprises sulfur, a metal catalyst, or both sulfur and a metal catalyst. Reference to “one or more” plates includes, in one embodiment, all plates in the system.

In view of the above, another embodiment of the invention includes a sorbent plate system comprising:
a stack of sorbent plates, wherein adjacent sorbent plates in the stack are separated by a flow space; and
wherein one or more of the sorbent plates comprise activated carbon and further comprise (i) sulfur, (ii) a metal catalyst, or (iii) sulfur and a metal catalyst. This plate system may be used as described above for the removal of metallic or semi-metallic contaminants from a fluid stream, as well as for the removal of any other type of contaminant from a fluid stream, such as a volatile organic compound.

Sulfur included in any sorbent plates of any embodiment of the invention may include elemental sulfur or sulfur at any oxidation state, including a sulfate, sulfite, sulfide (such as a metal sulfide), and including sulfur chemically bound to the activated carbon. The term sulfur thus includes elemental sulfur or sulfur present in a chemical compound or moiety.

A metal catalyst according to the invention includes any metal element in any oxidation state, as elemental metal or in a chemical compound or moiety comprising the metal, which is in a form that promotes the removal of a contaminant from the fluid stream in contact with a sorbent plate comprising the metal catalyst. Any metal catalyst included in the sorbent plates may include alkali metals, alkaline earth metals, noble metals, transition metals, rare earth metals (including lanthanoids), and other metals such as aluminum, gallium, indium, tin, lead, thallium and bismuth. Exemplary metals include manganese, copper, palladium, molybdenum, or tungsten. In one embodiment, the metal catalyst is bound to sulfur, such as in the form of a metal sulfide.

In additional exemplary embodiments, the catalyst is in a form selected from oxides, sulfides, halides, sulfates, nitrates, chlorides, acetates, hydroxides or metallorganic compounds. Some example catalysts further include CuO, CuS, MnS, MnO₂, MoS₂, Cr₂O₃, Fe₂O₃, CaO, Fe₂S₃, ZnTe, organometalic compounds such as Fe acetylacetonate, alkali or alkaline earth iodides, bromides, and chlorides.

The sorbent plates of any embodiments of the invention may have any shape, design, size, or texture appropriate for the removal of a contaminant from a fluid stream. For instance, one or plates may be flat, may comprise bends or curves, or may comprise corrugations. Reference to “one or more” plates in this context includes, in one embodiment, all plates of the plate system. The sorbent plates in any embodiments of the invention may also have any appropriate thickness, such as from 0.01 to 0.5 inches. In some embodiments, the surface area of one or more sorbent plates, such as plates comprising activated carbon, is from 50 m²/g to 2500 m²/g, such as from 400 m²/g to 1500 m²/g.

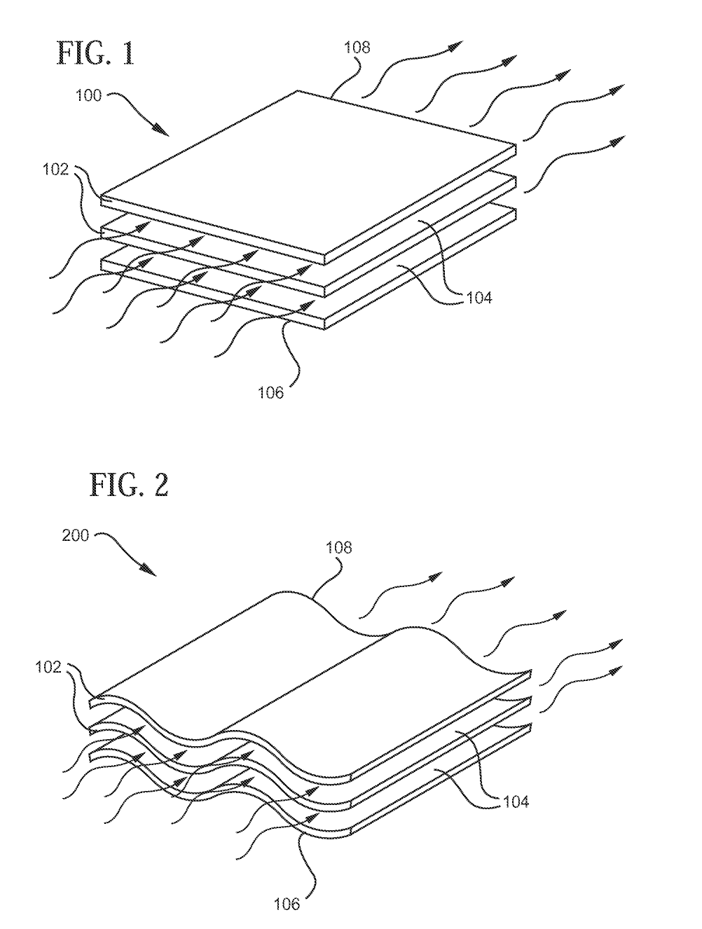

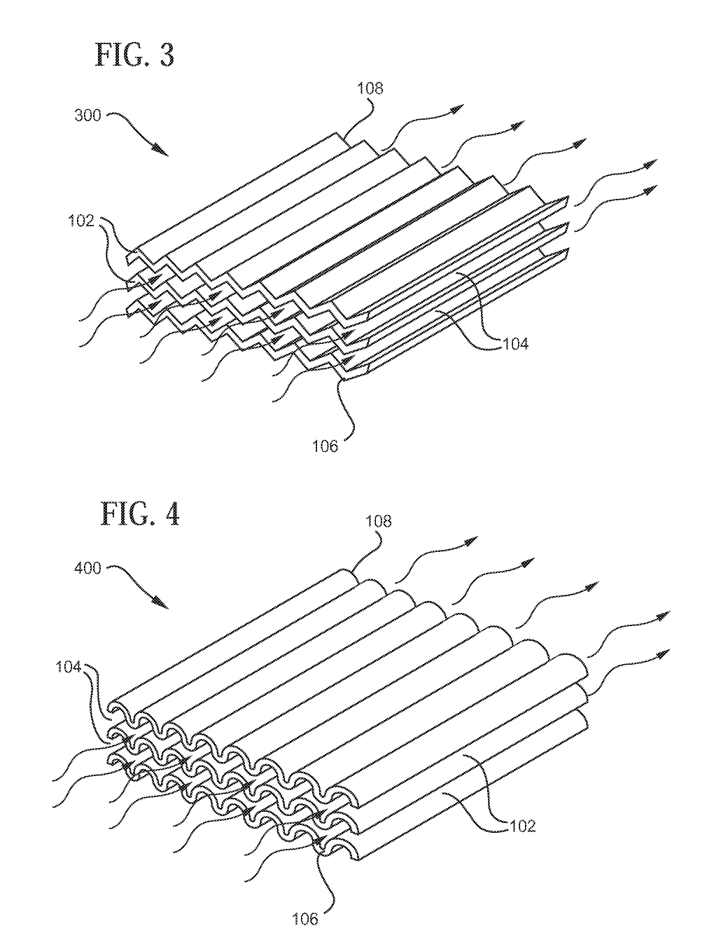

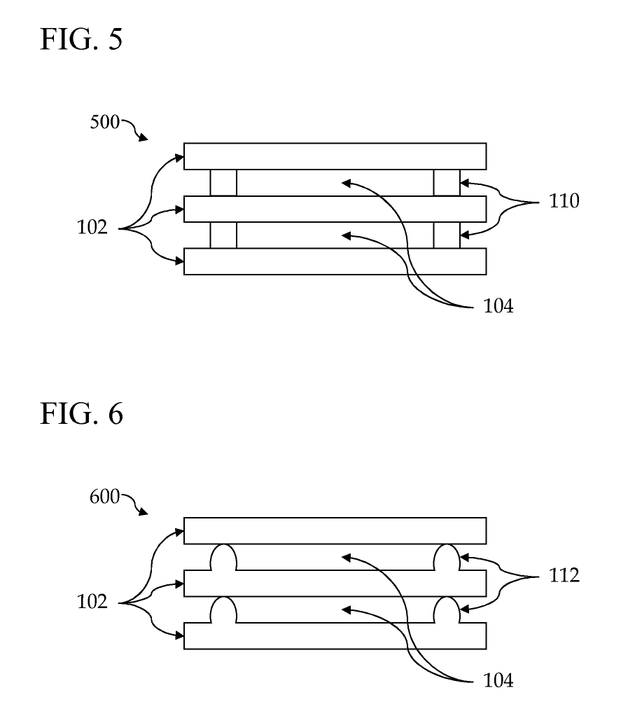

As a non-limiting example, FIG. 1 illustrates plate system 100 comprising flat sorbent plates 102, flow spaces 104, and inlet end 106 and outlet end 108 for the fluid stream (illustrated by arrows) passing through the flow spaces. Similarly, FIGS. 2, 3 and 4 illustrate example plate systems 200, 300 and 400, respectively, comprising sorbent plates 102, flow spaces 104, inlet ends 106, and outlet ends 108. The plates of FIG. 2 comprise curves, the plates of FIG. 3 comprise bends, and the plates of FIG. 4 comprise corrugations, as example forms of the plate systems. The plate system 500 of FIG. 5 illustrates spacers 110 between the sorbent plates 102. The sorbent plates 102 of plate system 600, shown in FIG. 6 comprise protrusions 112 forming gaps between the plates.

As shown in FIG. 1, for instance, the sorbent plates are parallel to each other. In other embodiments, one or more pairs of adjacent sorbents plates are not parallel to each other. For example, adjacent sorbent plates may be non-parallel to each other, thereby creating a flow space with a contour that varies in a direction parallel and/or perpendicular to the flow path of the fluid.

The sorbent plates may be incorporated into any system environment appropriate for practice of the invention. For example, the plate systems may be placed within a common enclosure, such as a duct through which a fluid stream containing a contaminant may pass. The sorbent plates of the plate systems of the invention may also be contacting or connected to each other or to various other supporting members, optionally with spacers placed between the plates to maintain a uniform distance between them across their surfaces. The plates themselves may also comprise protrusions or other embedded features, such as protrusions or other embedded features along one or more sides of their perimeters. The presence of spacers, protrusions, or other embedded features can allow for stacking multiple plates with the height of flow spaces being a function of the height of spacers, protrusions, or other embedded features forming a gap between plates in the stack.

The plate system of any embodiments may comprise any number of plates suitable for practice of the invention. For example, the plate systems may comprise at least 2, 3, 4, 5, 10, 20, 30, 40, or 50 plates in a stack.

The sorbent plates of any embodiments of the invention may be made by any suitable technique, including by extrusion, compression, injection molding, and casting. As one example, a sorbent plate comprising activated carbon may be made by providing a batch composition comprising activated carbon particles and an organic or inorganic binder, shaping the batch composition into the form of a plate, and optionally heat treating the plate. Sulfur or metal catalyst may optionally be included in the plate by the addition of sulfur or metal catalyst in the batch mixture or by applying sulfur or metal catalyst to the plate after it has been formed. For example, sulfur or metal catalyst may be added to the plate after it has been formed by dipping the plate in a composition comprising sulfur or metal catalyst or spraying a composition comprising sulfur or metal catalyst on the plate.

As another example, a composition such as one described in PCT/US08/06082, filed on May 13, 2008, may be mixed in the form of a powder with a binder to make a mixture and then formed into a plate with rollers, extruders or molds.

As another example, a sorbent plate comprising activated carbon may be made by providing a batch composition comprising a carbon precursor, shaping the batch composition into the form of a plate, optionally curing the composition, carbonizing the composition, and activating the carbonized composition. Sulfur or metal catalyst may optionally be included in the plate by the addition of sulfur or metal catalyst in the batch composition or by applying sulfur or metal catalyst to the plate after it has been formed, cured, carbonized, or activated.

Carbon precursors include synthetic carbon-containing polymeric material, organic resins, charcoal powder, coal tar pitch, petroleum pitch, wood flour, cellulose and derivatives thereof, natural organic materials such as wheat flour, wood flour, corn flour, nut-shell flour, starch, coke, coal, or mixtures or combinations of any two or more of these.

In one embodiment, the batch composition comprises an organic resin as a carbon precursor. Exemplary organic resins include thermosetting resins and thermoplastic resins (e.g., polyvinylidene chloride, polyvinyl chloride, polyvinyl alcohol, and the like). Synthetic polymeric material may be used, such as phenolic resins or a furfural alcohol based resin such as furan resins. Exemplary suitable phenolic resins are resole resins such as plyophen resins. An exemplary suitable furan liquid resin is Furcab-LP from QO Chemicals Inc., IN, U.S.A. An exemplary solid resin is solid phenolic resin or novolak.

If sulfur is added to the batch composition, the sulfur may be any source of sulfur in elemental or oxidized state. This includes sulfur powder, sulfur-containing powdered resin, sulfides, sulfates, and other sulfur-containing compounds, and mixtures or combination of any two or more of these. Exemplary sulfur-containing compounds include hydrogen sulfide and/or its salts, carbon disulfide, sulfur dioxide, thiophene, sulfur anhydride, sulfur halides, sulfuric ester, sulfurous acid, sulfacid, sulfatol, sulfamic acid, sulfan, sulfanes, sulfuric acid and its salts, sulfite, sulfoacid, sulfobenzide, sulfur containing organosilanes and mixtures thereof.

Sulfur may alternatively be impregnated onto an activated carbon support. In this regard, impregnation of sulfur can be done using a gas phase treatment using, for example, SO₂ or H₂S or through solution treatment using, for example, an Na₂S solution.

If a metal catalyst is added to the batch composition, the metal catalyst may be any source of metal catalyst in elemental or oxidized state. According to certain embodiments, the metal catalyst is provided from a source material selected from: (i) halides and oxides of alkali and alkaline earth metals; (ii) precious metals and compounds thereof; (iii) oxides, sulfides, and salts of vanadium, chromium, manganese, iron, cobalt, nickel, copper, zinc, niobium, molybdenum, silver, tungsten and lanthanoids; or (iv) combinations and mixtures of two or more of (i), (ii) and (iii). According to certain embodiments of the process, the metal catalyst-source material is in a form selected from: (i) oxides, sulfides, sulfates, acetates and salts of manganese; (ii) oxides, sulfides and salts of iron; (iii) combinations of (i) and KI; (iv) combinations of (ii) and KI; and/or (v) mixtures and combinations of any two or more of (i), (ii), (iii) and (iv). When the catalyst compound to be used is soluble, a solution of the metal catalyst may be added to the batch. If an insoluble compound is to be added then a finely ground powder may be added to the batch.

The batch compositions may optionally also include inert inorganic fillers, (carbonizable or non-carbonizable) organic fillers, and/or binders. Inorganic fillers can include oxide glass; oxide ceramics; or other refractory materials. Exemplary inorganic fillers that can be used include oxygen-containing minerals or salts thereof, such as clays, zeolites, talc, etc., carbonates, such as calcium carbonate, alumninosilicates such as kaolin (an aluminosilicate clay), flyash (an aluminosilicate ash obtained after coal firing in power plants), silicates, e.g., wollastonite (calcium metasilicate), titanates, zirconates, zirconia, zirconia spinel, magnesium aluminum silicates, mullite, alumina, alumina trihydrate, boehmite, spinel, feldspar, attapulgites, and aluminosilicate fibers, cordierite powder, mullite, cordierite, silica, alumina, other oxide glass, other oxide ceramics, or other refractory material.

Additional fillers such as fugitive filler which may be burned off during carbonization to leave porosity behind or which may be leached out of the formed plates to leave porosity behind, may be used. Examples of such fillers include polymeric beads, waxes, starch natural or synthetic materials of various varieties known in the art.

Exemplary organic binders include cellulose compounds. Cellulose compounds include cellulose ethers, such as methylcellulose, ethylhydroxy ethylcellulose, hydroxybutylcellulose, hydroxybutyl methylcellulose, hydroxyethylcellulose, hydroxymethylcellulose, hydroxypropylcellulose, hydroxypropyl methylcellulose, hydroxyethyl methylcellulose, sodium carboxy methylcellulose, and mixtures thereof. An example methylcellulose binder is METHOCEL A, sold by the Dow Chemical Company. Example hydroxypropyl methylcellulose binders include METHOCEL E, F, J, K, also sold by the Dow Chemical Company. Binders in the METHCEL 310 Series, also sold by the Dow Chemical Company, can also be used in the context of the invention. METHOCEL A4M is an example binder for use with a RAM extruder. METHOCEL F240C is an example binder for use with a twin screw extruder.

The batch composition may also optionally comprise forming aids. Exemplary forming aids include soaps, fatty acids, such as oleic, linoleic acid, sodium stearate, etc., polyoxyethylene stearate, etc. and combinations thereof. Other additives that can be useful for improving the extrusion and curing characteristics of the batch are phosphoric acid and oil. Exemplary oils include petroleum oils with molecular weights from about 250 to 1000, containing paraffinic and/or aromatic and/or alicyclic compounds. Some useful oils are 3 in 1 oil from 3M Co., or 3 in 1 household oil from Reckitt and Coleman Inc., Wayne, N.J. Other useful oils can include synthetic oils based on poly (alpha olefins), esters, polyalkylene glycols, polybutenes, silicones, polyphenyl ether, CTFE oils, and other commercially available oils. Vegetable oils such as sunflower oil, sesame oil, peanut oil, soyabean oil etc. are also useful.

The batch composition, such as one comprising a curable organic resin, may optionally be cured under any appropriate conditions. Curing can be performed, for example, in air at atmospheric pressures and typically by heating the composition at a temperature of from 70° C. to 200° C. for about 0.5 to about 5.0 hours. In certain embodiments, the composition is heated from a low temperature to a higher temperature in stages, for example, from 70° C., to 90° C., to 125° C., to 150° C., each temperature being held for a period of time. Additionally, curing can also be accomplished by adding a curing additive such as an acid additive at room temperature.

The composition can then be subjected to a carbonization step. For instance, the coating composition may be carbonized by subjecting it to an elevated carbonizing temperature in an O₂-depleted atmosphere. The carbonization temperature can range from 600 to 1200° C., in certain embodiments from 700 to 1000° C. The carbonizing atmosphere can be inert, comprising mainly a non reactive gas, such as N₂, Ne, Ar, mixtures thereof, and the like. At the carbonizing temperature in an O₂-depleted atmosphere, the organic substances contained in the batch mixture body decompose to leave a carbonaceous residue.

The carbonized composition may then be activated. The carbonized batch mixture body may be activated, for example, in a gaseous atmosphere selected from CO₂, H₂O, a mixture of CO₂ and H₂O, a mixture of CO₂ and nitrogen, a mixture of H₂O and nitrogen, and a mixture of CO₂ and another inert gas, for example, at an elevated activating temperature in a CO₂ and/or H₂O-containing atmosphere. The atmosphere may be essentially pure CO₂ or H₂O (steam), a mixture of CO₂ and H₂O, or a combination of CO₂ and/or H₂O with an inert gas such as nitrogen and/or argon. Utilizing a combination of nitrogen and CO₂, for example, may result in cost savings. A CO₂ and nitrogen mixture may be used, for example, with CO₂ content as low as 2% or more. Typically a mixture of CO₂ and nitrogen with a CO₂ content of 5-50% may be used to reduce process costs. The activating temperature can range from 600° C. to 1000° C., in certain embodiments from 600° C. to 900° C. During this step, part of the carbonaceous structure of the carbonized batch mixture body is mildly oxidized:

CO₂(g)+C(s)→2CO(g),

H₂O(g)+C(s)→H₂(g)+CO(g),

resulting in the etching of the structure of the carbonaceous body and formation of an activated carbon matrix that can define a plurality of pores on a nanoscale and microscale. The activating conditions (time, temperature and atmosphere) can be adjusted to produce the final product with the desired specific area.

### EXAMPLE 1

A batch composition was made including 6 wt % MnO₂, 13 wt % cordierite, 7 wt % sulfur, 19 wt % cellulose fiber, 5 wt % Methocel™ binder, 1 wt % sodium stearate, 47 wt % phenolic resole, 1 wt % phosphoric acid and 1 wt % oil. The batch composition was mixed thoroughly and then rolled through rollers maintained at 0.125″ distance. The composition was then cured, carbonized and activated to result in a sorbent plate.

### EXAMPLE 2

A batch composition was made including charcoal 37.2 wt %, sulfur 7.1 wt %, MnO₂ 7.1 wt %, Methocel™ 5.6 wt %, LIGA 1 wt %, phenolic resin 39.5 wt % and oil 2.5 wt %. The batch composition was mixed and rolled as described in Example 1 followed by drying, cure and carbonization and activation to result in a sorbent plate.

It should be understood that while the invention has been described in detail with respect to certain illustrative embodiments thereof, it should not be considered limited to such, as numerous modifications are possible without departing from the broad spirit and scope of the invention as defined in the appended claims.

We claim:

1. A method for removing a metallic or semi-metallic contaminant from a fluid stream, which comprises:
providing a system comprising a stack of sorbent plates, wherein adjacent sorbent plates in the stack are separated by a flow space; and
passing the fluid stream comprising a metallic or semi-metallic contaminant through one or more flow spaces in the stack;
wherein one or more of the sorbent plates comprise activated carbon and further comprise (i) sulfur, (ii) a metal catalyst, or (iii) sulfur and a metal catalyst.

2. A method of claim 1, which comprises removing a metallic contaminant from the fluid stream.

3. A method of claim 1, which comprises removing a semi-metallic contaminant from the fluid stream.

4. A method of claim 1, which comprises removing cadmium, mercury, chromium, lead, barium, beryllium, arsenic or selenium from the fluid stream.

5. A method of claim 1, wherein the fluid steam is a gas stream.

6. A method of claim 5, wherein the gas stream is a coal combustion flue gas.

7. A method of claim 5, wherein the gas stream is an oil combustion flue gas.

8. A method of claim 5, wherein the gas stream is a gas produced by coal gasification.

9. A method of claim 1, wherein one or more of the plates comprise a glass, a ceramic, a glass-ceramic, a metal, or activated carbon.

10. A method of claim 1 wherein one or more plates comprise activated carbon and sulfur.

11. A method of claim 1 wherein one or more plates comprise activated carbon and a metal catalyst.

12. A method of claim 1, wherein one or more of the plates comprise activated carbon and sulfur and a metal catalyst.

13. A sorbent plate system comprising:
a stack of sorbent plates, wherein adjacent sorbent plates in the stack are separated by a flow space; and
wherein one or more of the sorbent plates comprise activated carbon and further comprise (i) sulfur, (ii) a metal catalyst, or (iii) sulfur and a metal catalyst.

14. A system of claim 13, wherein one or more of the sorbent plates is a flat plate.

15. A system of claim 13, wherein one or more of the sorbent plates comprises one or more bends or curves.

16. A system of claim 13, wherein one or more of the sorbent plates comprise corrugations.

17. A system of claim 13, wherein one or more pairs of adjacent sorbents plates are parallel to each other.

18. A system of claim 13, wherein one or more pairs of adjacent sorbents plates are not parallel to each other.

19. A system of claim 13, wherein the thickness of the sorbent plates ranges from 0.01 to 0.5 inches.

20. A method for removing a contaminant from a fluid stream, which comprises:
passing a fluid stream comprising a contaminant through one or more flow spaces of the system of claim 13.

21. A method according to claim 1, wherein spacers, protrusions, or other embedded features form a gap between plates in the stack.

22. A method according to claim 1, wherein the stack of sorbent plates comprises at least 5 plates.

23. A sorbent plate system of claim 13, wherein spacers, protrusions, or other embedded features form a gap between plates in the stack.

24. A sorbent plate system of claim 13, wherein the stack of sorbent plates comprises at least 5 plates.
